(19) United States
(12) Patent Application Publication
(10) Pub. No.: US 2023/0025901 A1
(43) Pub. Date: Jan. 26, 2023

(54) GAME SYSTEM COMPRISING ROUNDED TOKENS OF DIFFERENT SETS AND BOARD WITH BUMPER ARRAY AND COLLECTION CHUTES

(71) Applicant: DARREN KOZAKEVICH, WINNIPEG (CA)

(72) Inventor: DARREN KOZAKEVICH, WINNIPEG (CA)

(21) Appl. No.: 17/863,537

(22) Filed: Jul. 13, 2022

Related U.S. Application Data
(60) Provisional application No. 63/221,519, filed on Jul. 14, 2021.

(51) Int. Cl. A63F 7/00; G07F 17/32

(52) U.S. Cl. CPC A63F 7/0058; G07F 17/3297

(57) ABSTRACT

A game system and related method comprise releasing playing tokens of visually distinguishable sets associated with different players in turn into a game board forming a generally vertically extending playing zone, so that the playing tokens move downwardly through an array of bumpers in the playing zone, which are arranged to deflect the playing tokens to randomize movement thereof, and collect in a token collection zone below the array of bumpers, which comprises a plurality of side-by-side chutes configured to receive the playing tokens, until a prescribed plural number of the playing tokens of a common one of the sets are located in a line in the token collection zone to define an initial winning set.

This application claims the benefit under 35 U.S.C. 119(e) of U.S. Provisional Application Ser. No. 63/221,519 filed Jul. 14, 2021.

### FIELD OF THE INVENTION

The present invention relates to a game system comprising rounded tokens of different sets and a board with an upright playing surface, a bumper array and collection chutes below the bumper array. The tokens move downwardly through the bumper array for subsequent receipt in the chutes.

### BACKGROUND

It is desirable to form a new game for entertainment, especially one which allows players to be relatively competitive regardless of experience and which is accessible basically to anyone regardless of physical ability.

### SUMMARY OF THE INVENTION

According to an aspect of the invention there is provided a game system comprising:
a board having longitudinally opposite upper and lower ends, laterally opposite sides and an upright playing surface;
two or more visually distinguishable sets of playing tokens for downward movement across the playing surface;
an array of bumpers supported adjacent the playing surface and at a spaced location from the lower end of the board, wherein the bumpers are arranged in a plurality of generally laterally extending rows which are arranged in longitudinally side-by-side relation to one another, wherein each one of the rows of the bumpers is offset relative to an adjacent one of the rows of the bumpers;
wherein the playing tokens have rounded peripheries and the bumpers are configured to deflect the playing tokens during downward movement thereof through the array of bumpers;
a token collection zone comprising a plurality of chutes supported adjacent the playing surface below the array of bumpers and configured for receiving the playing tokens, wherein the chutes are arranged in laterally side-by-side relation and extend longitudinally of the board from closed lower ends to open upper ends configured to receive the playing tokens therethrough;
wherein the chutes are sized to receive two or more of the playing tokens in stacked relation;
wherein a number of the chutes is not fewer than a maximum number of the playing tokens receivable in one of the chutes, such that a prescribed plural number of the playing tokens of a common set can be located in a line in the token collection zone.

Preferably, the chutes are each sized to receive the same number of the playing tokens.

Preferably, the number of the chutes is the same as the maximum number of the playing tokens receivable in one of the chutes.

Preferably, the array of bumpers is adjacent the upper end of the board.

Preferably, the token collection zone is adjacent the array of bumpers.

Preferably, the open tops of the chutes are at a common distance from the lower end of the board.

In one arrangement, the closed lower ends of the chutes are selectively openable to gravitationally release the playing tokens, and there is provided a collection bin below and adjacent the token collection zone configured to receive all of the playing tokens upon release therefrom.

Preferably, the lower ends of the chutes are formed by a common member configured to span generally laterally across the token collection zone, and the common member is movable relative to the board from a blocking position in which the member spans across the chutes to an unblocked position in which the member is located outside the playing surface, such that the playing tokens that have collected in the token collection zone are gravitationally releasable therefrom.

Preferably, the game system further includes a token nudging device configured for engaging the playing tokens and arranged to selectively protrude into a playing zone over the playing surface adjacent the upper ends of the chutes.

In one arrangement, the token nudging device comprises a rod supported in generally perpendicular orientation to the playing surface and configured to be movable in a generally lateral direction across the playing surface for engaging the playing tokens.

Preferably, the rod is movable between an out-of-play position in which the rod is located outside the playing zone and an in-play position in which the rod is located in the playing zone, and the rod is biased to the out-of-play position.

In one arrangement, the rod is slidably supported for movement between the out-of-play and in-play positions.

In one arrangement, the rod is slidably supported at one end thereof by the board and at a spaced location from said end by a wall supported in spaced relation and generally parallel condition to the board.

Preferably, there are provided a plurality of the token nudging devices on either side of the board.

In one arrangement, the token nudging device comprises a ball-engaging portion arranged for movement into and out of the playing zone and a gripping portion connected to the ball-engaging portion and configured to be received in a hand of a user, such that the token nudging device is manually actuatable by the user.

According to another aspect of the invention there is provided a method comprising:
releasing playing tokens of visually distinguishable sets associated with different players in turn into a game board forming a generally vertically extending playing zone, so that the playing tokens move downwardly through an array of bumpers in the playing zone, which are arranged to deflect the playing tokens to randomize movement thereof, and collect in a token collection zone below the array of bumpers, which comprises a plurality of side-by-side chutes configured to receive the playing tokens, until a prescribed plural number of the playing tokens of a common one of the sets are located in a line in the token collection zone to define an initial winning set.

Preferably, when one of the playing tokens stops in the playing zone in proximity to but outside the chutes, so as to define a stuck playing token, the method further includes nudging the stuck playing token in a generally horizontal direction to fall into a proximal one of the chutes.

Preferably, if the stuck playing token stops over an inward one of the chutes that is spaced from a side edge of the playing zone, then the direction of nudging is determined by one of the players associated with a next one of the playing tokens to be released.

In one arrangement, the method further includes releasing one of the playing tokens of one of the subsets different from the initial winning subset, and if said one of the playing tokens forms a line of the prescribed plural number of the playing tokens of the corresponding subset, then the method further includes releasing the playing tokens of the visually distinguishable sets in turn until another line of a prescribed plural number of the playing tokens of a common one of the sets is formed. Otherwise, the initial winning set determines the winner.

Preferably, the playing tokens are configured to move through the playing zone by gravity. Alternatively, when the method is performed on a computing device such as a smartphone, the playing tokens are configured to move through the playing zone by programming instructions stored on a non-transitory memory, which are executed on a processor of the computing device operatively communicated with the memory.

### BRIEF DESCRIPTION OF THE DRAWINGS

The invention will now be described in conjunction with the accompanying drawings in which:

FIG. 1 schematically illustrates a front elevational view of a game system according to an arrangement of the present invention;

FIG. 2 is a cross-sectional view along line 2-2 in FIG. 1;

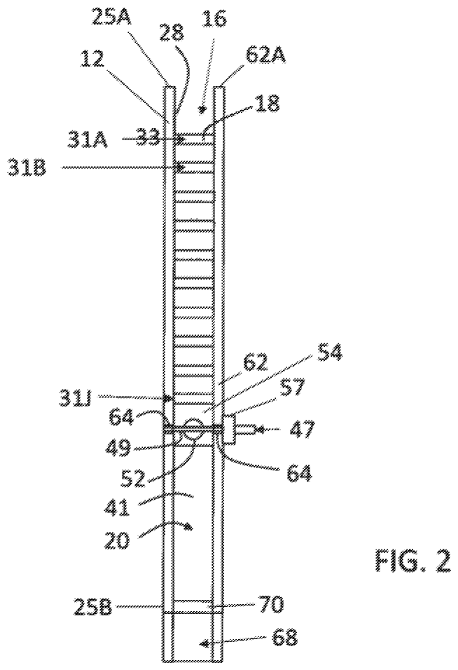

FIG. 3 is a cross-sectional view along line 3-3 in FIG. 1, in which one token nudging device is shown in an out-of-play position and another is shown in an in-play position; and

FIG. 4 schematically illustrates a front elevational view of the arrangement of FIG. 1 but with a blocking member for releasing tokens in a token collection zone shown in an unblocked position.

In the drawings like characters of reference indicate corresponding parts in the different figures.

### DETAILED DESCRIPTION

The accompanying drawings show a game system 10 comprising a game board 12 and a plurality of playing tokens or chips 14 to be released for movement across the game board.

Basically, a game played on the system 10 comprises releasing the playing tokens 14, of which there are different visually distinguishable sets associated with different players, in turn into the game board 12, which forms a generally vertically extending playing zone 16, so that the playing tokens move downwardly through an array of bumpers 18 in the playing zone, which are arranged to deflect the playing tokens to randomize movement thereof. Subsequently, the playing tokens collect in a token collection zone 20 below the array of bumpers 18, which zone comprises a plurality of side-by-side chutes 22 configured to receive the playing tokens, until a prescribed plural number of the playing tokens of a common one of the sets are located in a line in the token collection zone to define an initial winning set, and accordingly a winning player.

Dynamics of the game are of course facilitated by the design of the game board 12 and the playing tokens 14.

The game board 12 has longitudinally opposite upper and lower ends 25A and 25B, laterally opposite sides 26A and 26B and an upright playing surface 28 over which the playing zone 16 is defined. In a physical embodiment, the game board is formed by a sheet-like member with a planar face defining the playing surface 28, and the sheet-like member is oriented in upstanding fashion so that one end is located above the other to define the upper and lower ends 25A, 25B. Furthermore, in one arrangement, the game board 12 may be configured for mounting on a building wall at a spaced height above a floor surface, for example by including brackets on a rear face of the board that is opposite to the playing surface 28, for accepting fasteners.

The playing tokens 14 are for downward movement across the playing surface 28. There is a plurality of visually distinguishable sets of the tokens, for example 29A through 29C, which are visually differentiated from each other by a visually distinguishing feature such as color or visual markings or indicia, like symbols or letters, as the tokens of the illustrated arrangement. Each token of a common set shares the visually distinguishing feature corresponding to that set. Each visually distinguishable set of the tokens is associated with a respective one of the game players or a team of one or more of the players.

For a physical embodiment of the game board, the downward movement of the playing tokens 14 through the playing zone 16 is gravitational, whereas for a computer-implemented embodiment, downward movement of the tokens is effected by programming instructions stored on a non-transitory memory and executed on a processor of a computing device operatively communicated with the memory, on which device the game is played.

To randomize movement of the playing tokens across the game board, the game board 12 includes the array of bumpers 18 supported adjacent the playing surface 28 and at a spaced location from the lower end of the board 25B. The bumpers 18 are arranged in a plurality of generally laterally extending rows, such as those indicated at 31A through 31J, which are arranged in longitudinally side-by-side relation to one another. In other words, the rows extend in a direction from one side 26A or 26B of the board towards the other. Each one of the rows of the bumpers is offset relative to an adjacent one of the rows of the bumpers, as for example bumper row 31B is in relation to bumper row 31A. Thus, for each bumper row except for a lowest one thereof, in this case 31J, there is presented between each adjacent pair of bumpers an intervening bumper in the row thereunder, which acts to induce side-to-side movement as the playing tokens pass downwardly through gaps defined by each adjacent pair of bumpers of a common row.

Furthermore, the bumpers 18 are configured to deflect the playing tokens 14 during downward movement thereof through the bumper array, for example by having rounded peripheries such as in cross-section around a transverse axis to the playing surface 28.

The playing tokens 14 also are configured to deflect off the bumpers by having rounded peripheries to enable deflection while substantially maintaining momentum from their downward movement. This rounded shape is relative to an upstanding axis to the playing surface 28, which allows the tokens to bounce off the deflectors without the shapes otherwise impeding downward movement for example by forming a ledge perpendicular to the longitudinal direction or by accidentally mechanically interlocking. For example, the tokens may be spherical or generally cylindrical in shape, like a puck or disk.

Thus, the bumpers form static elements which act to deflect the playing tokens, which are dynamic elements of the game system.

There are also provided zigzagged upper portions 33 of sidewalls 34 of the gameboard at the sides 26A, 26B which generally follow outer sides of the bumper array, defined by outermost bumpers of the rows, to confine the tokens in movement around outermost bumpers. Thus, a played or released token deflects around an outermost one of the bumpers in any row, the zigzagged sidewalls 33 act to guide the token back towards the array. In the illustrated arrangement, the zigzagged sidewalls 33 are formed by triangular inserts, which are, for example, isosceles triangle-shaped, arranged at spaced positions along the linear sidewalls 34, with the equal-length sides of the triangles protruding into the playing zone 16 at longitudinal locations of the rows with fewer bumpers.

The playing tokens 14 ultimately fall into the token collection zone 20 which comprises the plurality of chutes 22. The chutes 22 are supported adjacent the playing surface 28 below the array of bumpers 18 and are configured for receiving the playing tokens 14, for example by being sized in width between opposite chute walls 41 slightly larger than diameters of the tokens. The chutes 22 are arranged in laterally side-by-side relation and extend longitudinally of the board 12 from closed lower ends 43A to open upper ends 43B configured to receive the playing tokens therethrough.

The chutes 22 are sized to receive two or more of the playing tokens in stacked relation. That is, the chutes 22 are configured to receive multiple playing tokens one on top of the other to form generally vertically extending stacks inside the chutes.

A number or quantity of the chutes 22 is not fewer than a maximum number of the playing tokens 14 receivable in one of the chutes. In other words, the number of chutes is greater than or equal to the maximum number of the playing tokens receivable in one the chutes.

As such, a prescribed plural number of the playing tokens 14 of a common one of the visual markings can be located in a line in the token collection zone 20. Basically, this linear configuration of the tokens of a common set can be formed by (i) tokens in a common chute, or (ii) tokens in laterally adjacent relation in adjacent chutes, which may lie along a common horizontal or inclined axis intersecting each token of the common set. This arrangement determines the winner of the game, who is associated with the set of the tokens arranged in linear configuration, where the set is identified by a visually distinguishing feature.

In the illustrated arrangement, the chutes 22 are each sized to receive the same number of the playing tokens 14. Furthermore, the open tops of the chutes are at a common distance from the lower end 25B of the board 12, and the number of the chutes is the same as the maximum number of the playing tokens receivable in one of the chutes. Thus, the token collection zone 20 enables the tokens to be arranged in a square grid having an equal number of rows and columns.

In the illustrated arrangement, the bumper array 18 is adjacent the upper end 25A of the board. Thus, the bumpers 18 are the first elements of the game board which affect the downward movement of the playing token, so as to randomly alter their downward paths across the playing surface 28.

Also, in the illustrated arrangement, the token collection zone 20 is adjacent the array of bumpers 18. As such, the playing zone 16 of the game board 12, which is a space where the tokens 14 move through various elements of the board 12 which manipulate their downward movement, consists essentially of the bumper array 18 and the token collection zone 20 which is configured to receive the tokens in a grid-like configuration.

In addition, the bumpers 18 of the lowest and last row of the bumper array, which in this case is that at 31J, are arranged longitudinally in-line with the walls 41 of the chutes 22, such that each gap between adjacent bumpers in the last row is registered with one of the chutes. This reduces likelihood of tokens landing outside the chutes, by landing on the walls thereof, after exiting the bumper array.

However, if a token inadvertently comes to rest outside the chutes 22, the game board 12 further includes a token nudging device 47 configured for engaging the playing tokens and arranged to selectively protrude into the playing zone 16 over the playing surface 28 adjacent the upper ends 43A of the chutes. In the illustrated arrangement, a plurality of such devices 47 is provided on either side 26A, 26B of the board, specifically one on each side of the board.

Generally speaking, the token nudging device 47 comprises a ball-engaging portion arranged for movement into and out of the playing zone 16. In the illustrated arrangement, this is in the form of a rod 49 supported in generally perpendicular orientation to the playing surface 28 and configured to be movable in a generally lateral direction across the playing surface 28 for engaging the playing tokens. In other words, the rod is oriented in upstanding condition to the playing surface 28 and is movable in a direction from one side 26A or 26B of the board towards the other, which is transverse to the chute walls 41, so as to knock the token into a chute which is not full.

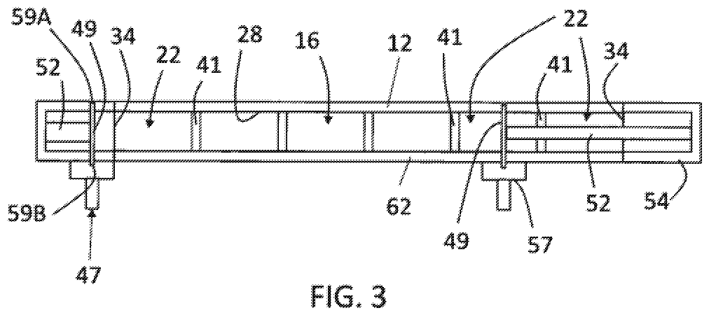

As more clearly shown in FIG. 3, the rod 49 is movable between an out-of-play position in which the rod is located outside the playing zone and an in-play position in which the rod is located in the playing zone. The rod 49 is biased to the out-of-play position by a biasing member 52 such as a tension spring, which is connected at one end to the rod 49 and at an opposite end to a mounting member 54 fixed in relation to the game board 12, and which is configured to compress to urge its ends towards one another when tensioned. In the illustrated arrangement, the mounting member 54 is in the form of a container mounted to one side of the game board, such as 26A.

For actuation, the token nudging device 47 of the illustrated arrangement includes a gripping portion 57 connected to the ball-engaging portion 49 and configured to be received in a hand of a user, such that the token nudging device 47 is manually actuatable by the user, that is a player. The gripping portion 57 may be in the form of a handle having an enlarged base and a projecting shaft.

The rod 49 is slidably supported for movement between the out-of-play and in-play positions. More specifically, this is achieved by supporting one end 59A of the rod by the board 12 and the rod at a spaced location from the board-supported end, for example an opposite end 59B of the rod, by a wall 62 supported in spaced relation and generally parallel condition to the board 12 such that the playing zone 16 has substantially uniform depth between the playing surface 28 and the wall 62. The rod 49 is displaced along slots 64 in each of the board 12 and the parallel wall 62 configured to slidably guide the rod 49 across the playing zone and over the chutes.

The wall 62 is transparent for viewing the tokens in the playing zone 16 and is supported by the sidewalls 34 of the board, so as to form a container for receiving the tokens. The transparent wall 62 is spaced from the playing surface 28 by a distance slightly larger than diameters of the playing tokens 14, which are all identical besides the visually distinguishing features, to confine the playing tokens such that they are in uninterrupted contact with the playing surface 28 during their downward movement through the playing zone 16. When the playing surface 28 is planar, as in the illustrated arrangement, and a physical game board is vertically oriented, the movement of the tokens is affected substantially by gravity and by deflection off the bumpers 18 only, and there is minimal frictional interference on the token movement due to either the board 12 or the wall 62.

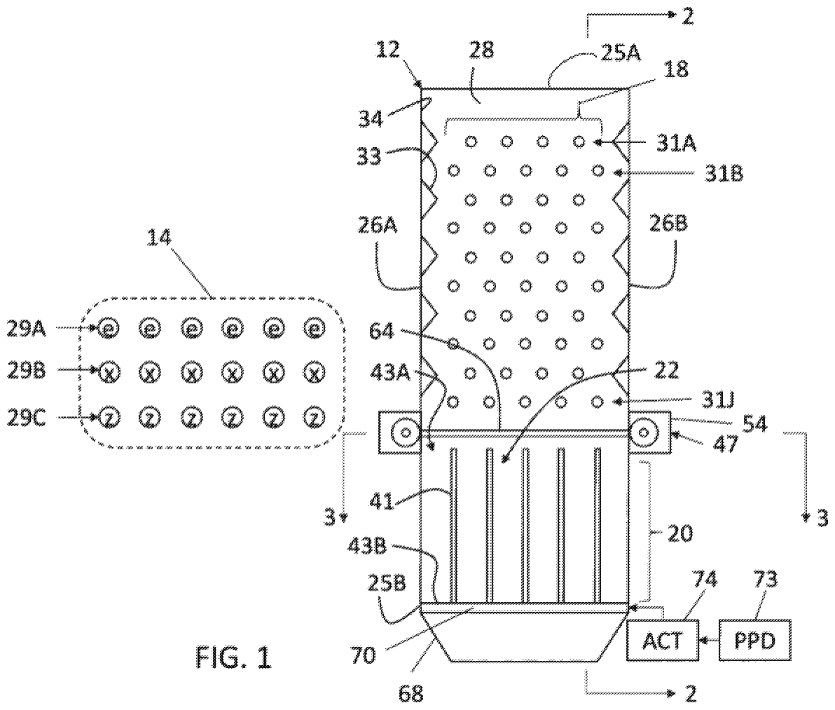

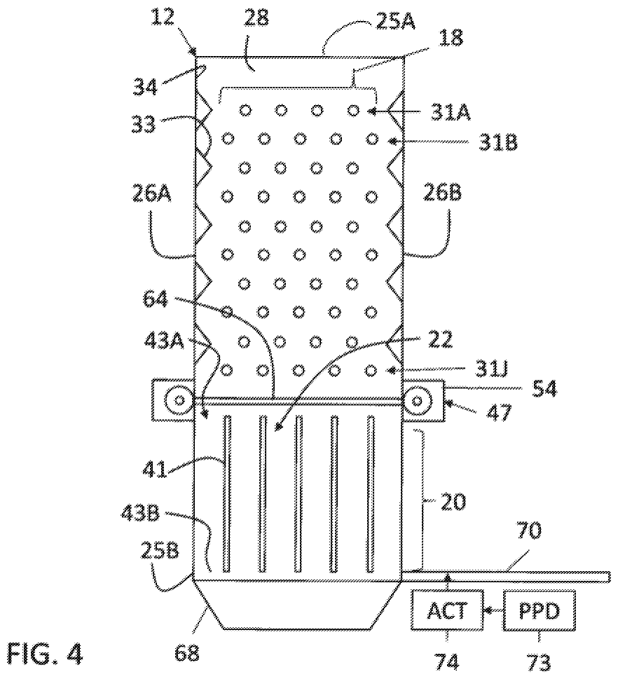

To restart concluded or finished gameplay, that is after a line of tokens of the same set has been formed to determine a winner, the tokens 14 are released from the token collection zone 20 where they are temporarily stored during gameplay and thereafter until it is desired to restart. As such, and particularly in the physical embodiment of the game system 10, the closed lower ends 43B of the chutes 22 are selectively openable to gravitationally release the playing tokens, and there is provided a collection bin 68 below and adjacent the token collection zone 20 configured to receive all the playing tokens upon release therefrom. To provide this functionality, the lower ends 43B of the chutes are formed by a common blocking member 70 configured to span generally laterally across the token collection zone 20, and the blocking member is movable relative to the board 12 from a blocking position, as shown in FIG. 1, in which the member spans across the chutes 22, to an unblocked position in which the member is located outside the playing zone 16, as shown in FIG. 4, such that the playing tokens 14 that have collected in the token collection zone 20 are gravitationally releasable therefrom. The blocking member 70 may be configured to pass through an opening in one of the sidewalls 34.

In the illustrated arrangement of the game system which is particularly suited for commercial use, for example in a game room, movement of the blocking member 70 from the blocking position to the unblocking position is mechanically actuated responsive to receipt of payment from a user. In such an arrangement, the game system includes a payment processing device 73 operatively coupled to an actuator 74, such as a linear actuator, which is operatively coupled to the blocking member 70 and configured to drive movement of the blocking member between the blocking and unblocked positions. The payment processing device 73 may be configured to receive coins (so as to be coin-operated) or electronic payment, such as by credit card. The actuator 74 may comprise a pneumatic cylinder or a manual lever, for example that which has coin slots so as to be configured to receive payment in the form of coins.

It will be appreciated that, particularly in the physical embodiment of the game system 10, the upper end 25A of the game board and an end 62A of the viewing wall 62 opposite thereto form, with the sidewalls 34, an open upper end into which the playing tokens can be deposited for subsequent movement through the playing zone 16.

In use, as previously mentioned, gameplay comprises releasing playing tokens 14 of different visually distinguished sets such as 29A-29C associated with different players in turn into a game board 12 forming a generally vertically extending playing zone 16, so that the playing tokens 14 move downwardly through an array of bumpers 18 in the playing zone 16, which are arranged to deflect the playing tokens to randomize movement thereof tending in the downward direction, and collect in a token collection zone 20 below the array of bumpers, which comprises a plurality of side-by-side chutes 22 configured to receive the playing tokens, until a prescribed plural number of the playing tokens of a common one of the sets are located in a line in the token collection zone to define an initial winning subset.

When the token collection zone 20 is configured to receive the tokens in a square grid-like configuration, as in the illustrated arrangement, the prescribed plural number of tokens for forming the linear configuration is less than a number of the chutes which is the same value as a maximum number of tokens receivable in any one of the chutes. For example, when there are six chutes, the prescribed plural number of tokens is four.

In the physical embodiment of the game system 10, releasing the playing tokens 14 into the game board comprises depositing the tokens into the playing zone 16, typically by dropping the tokens through the open upper end of the game board.

When one of the playing tokens 14 stops in the playing zone 16 in proximity to but outside the chutes 22, so as to define a stuck playing token, the method of gameplay further includes nudging the stuck playing token in a generally horizontal direction to fall into a proximal one of the chutes. The stuck playing token may land either on one of the walls 41 of the chutes or on another token in a full one of the chutes containing the maximum number of playing tokens it can receive.

If the stuck playing token stops over an inward one of the chutes that is spaced from a side edge or side 26A, 26B of the playing zone, then the direction of nudging is determined by one of the players associated with a next one of the playing tokens to be released. That is, the player whose turn follows the player who released the stuck token decides a preferred direction of nudging, whether left or right.

Gameplay may be extended even after the line of common tokens is formed by allowing for release of one of the playing tokens of one of the sets different from the initial winning subset, typically that corresponding to the player whose turn would follow the winner, and if the released playing token lands in the token collection zone 20 to form a line of the prescribed plural number of the playing tokens of the corresponding set, then the gameplay further includes releasing the playing tokens of the different subsets in turn until another line of a prescribed plural number of the playing tokens of a common one of the subsets is formed. In other words, the gameplay resumes until the next line of tokens of a common visual feature is formed. Otherwise, the initial winning set wins.

As described hereinbefore, the present invention relates to a game system and related method which is a combination of Plinko and Connect4.

The board consists of two major parts. The first is a series of spaced-out pegs or bumpers with each consecutive row below it having another bumper in the middle all the way to the bottom. This grid layout is similar to the game Plinko.

The second part of the board introduces 6 individual slots that are 6 balls deep, for a grid of 6×6. This area plays out a game similar to Connect 4.

This allows for the strategy of a game like Connect 4 with the randomness and excitement of a game like Plinko. The first player who gets 4 balls in either a vertical, horizontal or diagonal line wins. Their opponent gets one extra shot after the victory to try to tie them in a “redemption” If this is unsuccessful then the game is over and their opponent wins. If the attempt at redemption and a tying connect 4 is made then there is a play off for two separate lines of 4.

If a ball falls to rest on top of a full vertical column of 6 and has nowhere to go then the ball must be pushed to its next available slot with the nudging bumper. (a pole that comes out each side at the top of the 6×6 grid) If player 1 drops the ball on a full column where there is an option to go left or right then player 2 gets to choose which direction they wish to nudge the ball. (This also adds to the strategy of gameplay).

There is strategy to aim for the slot you wish to shoot at or block your opponent, however, because of this randomness we have found that even beginner players who throw random balls will still win about 40% of the games. This aspect alone creates the possibility of the youngest or least experienced players legitimately beating even the most experienced players and thus creates the addictive playing experience. This game can be played with anywhere between 2-6 players, and you would simply make teams and take turns dropping balls in turn.

The game both large and small is portable and can also be played outside.

Games may also add simple dare cards for the loser to add to excitement for both children and adult versions.

One embodiment of the game system particularly suited for household gameplay and may comprise a lightweight plastic molded game board, with plastic disks in the style of connect 4, and a second grid that snaps up and into place on top of the connect 4 board with the bumper grid to randomize the game. Both grids would be about a foot by a foot, so when mounted it would be 2 feet tall by 1 foot wide. A plastic stick would be included to poke any disks that land on the top of the 6th row.

Another embodiment of the game system suited particularly suited for a commercial game room ma be constructed like a pool table, with a similar green, blue or red felt, and rubber bumpers or pegs and similar weight billiard balls. The game would be roughly a yard and a half tall by about 2 feet wide. This could be mounted onto any wall and shown off proudly by its owner as a symbol of beauty, decor and fun.

The scope of the claims should not be limited by the preferred embodiments set forth in the examples but should be given the broadest interpretation consistent with the specification as a whole.

1. A game system comprising:
a board having longitudinally opposite upper and lower ends, laterally opposite sides and an upright playing surface;
two or more visually distinguishable sets of playing tokens for downward movement across the playing surface;
an array of bumpers supported adjacent the playing surface and at a spaced location from the lower end of the board, wherein the bumpers are arranged in a plurality of generally laterally extending rows which are arranged in longitudinally side-by-side relation to one another, wherein each one of the rows of the bumpers is offset relative to an adjacent one of the rows of the bumpers;
wherein the playing tokens have rounded peripheries and the bumpers are configured to deflect the playing tokens during downward movement thereof through the array of bumpers;
a token collection zone comprising a plurality of chutes supported adjacent the playing surface below the array of bumpers and configured for receiving the playing tokens, wherein the chutes are arranged in laterally side-by-side relation and extend longitudinally of the board from closed lower ends to open upper ends configured to receive the playing tokens therethrough;
wherein the chutes are sized to receive two or more of the playing tokens in stacked relation;
wherein a number of the chutes is not fewer than a maximum number of the playing tokens receivable in one of the chutes, such that a prescribed plural number of the playing tokens of a common set can be located in a line in the token collection zone.

2. The game system of claim 1 wherein the chutes are each sized to receive the same number of the playing tokens.

3. The game system of claim 1 wherein the number of the chutes is the same as the maximum number of the playing tokens receivable in one of the chutes.

4. The game system of claim 1 wherein the array of bumpers is adjacent the upper end of the board.

5. The game system of claim 1 wherein the token collection zone is adjacent the array of bumpers.

6. The game system of claim 1 wherein the open tops of the chutes are at a common distance from the lower end of the board.

7. The game system of claim 1 wherein the closed lower ends of the chutes are selectively openable to gravitationally release the playing tokens and there is provided a collection bin below and adjacent the token collection zone configured to receive all of the playing tokens upon release therefrom.

8. The game system of claim 1 wherein the lower ends of the chutes are formed by a common member configured to span generally laterally across the token collection zone, and wherein the common member is movable relative to the board from a blocking position in which the member spans across the chutes to an unblocked position in which the member is located outside the playing surface, such that the playing tokens that have collected in the token collection zone are gravitationally releasable therefrom.

9. The game system of claim 1 further including a token nudging device configured for engaging the playing tokens and arranged to selectively protrude into a playing zone over the playing surface adjacent the upper ends of the chutes.

10. The game system of claim 9 wherein the token nudging device comprises a rod supported in generally perpendicular orientation to the playing surface and configured to be movable in a generally lateral direction across the playing surface for engaging the playing tokens.

11. The game system of claim 10 wherein the rod is movable between an out-of-play position in which the rod is located outside the playing zone and an in-play position in which the rod is located in the playing zone, and wherein the rod is biased to the out-of-play position.

12. The game system of claim 10 wherein the rod is slidably supported for movement between the out-of-play and in-play positions.

13. The game system of claim 12 wherein the rod is slidably supported at one end thereof by the board and at a spaced location from said end by a wall supported in spaced relation and generally parallel condition to the board.

14. The game system of claim 9 wherein there are provided a plurality of the token nudging devices on either side of the board.

15. The game system of claim 9 wherein the token nudging device comprises a ball-engaging portion arranged for movement into and out of the playing zone and a gripping portion connected to the ball-engaging portion and configured to be received in a hand of a user, such that the token nudging device is manually actuatable by the user.

16. A method comprising:
releasing playing tokens of visually distinguishable sets associated with different players in turn into a game board forming a generally vertically extending playing zone, so that the playing tokens move downwardly through an array of bumpers in the playing zone, which are arranged to deflect the playing tokens to randomize movement thereof, and collect in a token collection zone below the array of bumpers, which comprises a plurality of side-by-side chutes configured to receive the playing tokens, until a prescribed plural number of the playing tokens of a common one of the sets are located in a line in the token collection zone to define an initial winning set.

17. The method of claim 16 wherein, when one of the playing tokens stops in the playing zone in proximity to but outside the chutes, so as to define a stuck playing token, the method further includes nudging the stuck playing token in a generally horizontal direction to fall into a proximal one of the chutes.

18. The method of claim 17 wherein, if the stuck playing token stops over an inward one of the chutes that is spaced from a side edge of the playing zone, then the direction of nudging is determined by one of the players associated with a next one of the playing tokens to be released.

19. The method of claim 16 further including releasing one of the playing tokens of one of the subsets different from the initial winning subset, and if said one of the playing tokens forms a line of the prescribed plural number of the playing tokens of the corresponding subset, then the method further includes releasing the playing tokens of the visually distinguishable sets in turn until another line of a prescribed plural number of the playing tokens of a common one of the sets is formed.

20. The method of claim 16 wherein the playing tokens are configured to move through the playing zone by gravity.
